(19) United States
(12) Patent Application Publication
(10) Pub. No.: US 2026/0179347 A1
(43) Pub. Date: Jun. 25, 2026

(54) METHOD AND APPARATUS FOR GENERATING SEGMENTATION MASKS FROM A TASK PERFORMANCE VIDEO

(71) Applicant: Worcester Polytechnic Institute, Worcester, MA (US)

(72) Inventors: Galen Brown, Worcester, MA (US); Berk Calli, Boston, MA (US)

(73) Assignee: Worcester Polytechnic Institute, Worcester, MA (US)

(21) Appl. No.: 19/425,638

(22) Filed: Dec. 18, 2025

Related U.S. Application Data
(60) Provisional application No. 63/736,427, filed on Dec. 19, 2024.

(51) Int. Cl. G06V 10/26; B07C 5/342; G06T 7/187; G06T 7/215; G06T 7/277; G06V 10/25; G06V 10/774; G06V 20/70

(52) U.S. Cl. CPC G06V 10/267; B07C 5/3422; G06T 7/187; G06T 7/215; G06T 7/277; G06V 10/25; G06V 10/774; G06V 20/70; G06T 2207/10016; G06T 2207/20081; G06T 2207/30242

(57) ABSTRACT

Embodiments of the innovation relate to a method for generating a labeled object data set. The method comprises receiving a task performance video, playing the task performance video in reverse, and for each video frame of the task performance video, applying a mask to images of the objects within the object stream. The method further comprises identifying an object entering a first video frame of the task performance video along a direction perpendicular to a direction of the object stream, in response to detecting motion of the identified object from the first video frame of the task performance video to a second video frame of the task performance video along the perpendicular direction, designating the object as an object of interest, and storing mask segmentation data associated with the mask of the object of interest as part of the labeled object data set.

### RELATED APPLICATIONS

This patent application claims the benefit of U.S. Provisional Application No. 63/736,427 filed on Dec. 19, 2024, entitled “Method and Apparatus for Generating Segmentation Masks from a Task Performance Video,” the contents and teachings of which are hereby incorporated by reference in their entirety.

### GOVERNMENT LICENSE RIGHTS

This invention was made with government support under Grant #1928506 awarded by the National Science Foundation. The government has certain rights in the invention.

### BACKGROUND

Product stream sorting techniques can be utilized within a variety of industries. For example, certain industries may need to organize items within a product stream by particular criteria, such as product destination, type, or quality. Other industries utilize sorting techniques to remove contaminants from a product stream or to create higher-value material streams, such as in recycling.

Product stream sorting can involve various types of mechanisms. For example, an organization can utilize imaging technology, such as cameras, lasers, or X-ray devices, to identify particular items in a product stream. Organizations can also utilize logic applications, such as a Warehouse Management System (WMS) application, to automatically identify and direct items to specific destinations (e.g., chutes, bins) based on attributes like size, color, density, or barcode.

### SUMMARY

Conventional product stream sorting suffers from a variety of deficiencies. For example, in particular industries, such as within the recycling industry, conventional American Material Reclamation Facilities (MRFs) can identify materials (e.g., metal, glass, plastic, etc.) within a product stream and can remove the identified materials on-the-fly. However, despite investment in mechanical infrastructure for material separation, human labor remains a necessary component of waste separation to remove “out-of-set” materials that cannot be properly handled. Further, the Environmental Protection Agency (EPA) has provided a goal of recycling fifty percent of all domestic waste by 2030. In order for MRFs to meet the EPA goals, an enormous increase in recycling throughput will be required, particularly in the categories which are currently the most difficult to sort, such as glass and plastics.

To meet these goals, MRFs can utilize robotic automation for product stream sorting. However, the relatively cluttered and occluded environments of MRFs provide a challenging domain for computer vision. Further, conventional computer vision algorithms used in robotic automation require relatively large volumes of data to train, and recycling is highly heterogenous—waste varies wildly in composition across small regions, and even in the same region with time. As such, collecting and labeling sufficient data to produce accurate results requires massive, ongoing work.

To avoid the difficulties of labeling training data, MRFs can utilize synthetic data to train the computer vision algorithms. The traditional approach to synthetic data generation involves the creation of a simulated environment with known ground truths and the generation of training data from this environment. The risk with this strategy involves domain adaptation. If the simulation is insufficiently realistic, the data it produces will not meaningfully reflect real world problems. This is a major problem for recycling segmentation, which is already extremely sensitive to domain changes.

By contrast to conventional synthetic training data generation techniques, embodiments of the present innovation relate to a method and apparatus for generating segmentation masks from a task performance video. In one arrangement, a video recording device records a manual object separation process where a human operator make decisions to sort objects from an object stream based on visual information. For example, the operator can be instructed to select and remove particular items or objects (e.g., plastic bottles, aluminum cans, etc.) from an object stream, such as a provided via a conveyor. A segmentation masking apparatus can receive the video recording of the manual object separation process and identify the objects picked by the sorting worker. The apparatus then tracks the picked objects throughout the video and take its pictures in non-visually-occluded states. This allows the segmentation masking apparatus to produce pixel-wise masks and labels for the removed objects without requiring additional human supervision and to generate a resulting labeled object data set.

The segmentation masking apparatus can utilize the labeled object data set to train a sorting algorithm to generate a sorting engine. A sorting apparatus can apply video data from an object stream to the training engine to identify objects of interest (e.g., plastic bottles, aluminum cans, etc.). Based on the identification, the sorting apparatus can generate and transmit a signal to one or more robotic devices to remove the identified object from the object stream. The segmentation masking apparatus can also be configured to develop artificial intelligence (AI) algorithms that monitor the process to provide quality control data (e.g., the success of the sorting operation on a conveyor line).

Embodiments of the innovation relate to, in a segmentation masking apparatus, a method for generating a labeled object data set. The method comprises receiving a task performance video, the task performance video showing of objects within an object stream, playing the task performance video in reverse, and for each video frame of the task performance video, applying a mask to images of the objects within the object stream. The method further comprises identifying an object entering a first video frame of the task performance video along a direction perpendicular to a direction of the object stream, in response to detecting motion of the identified object from the first video frame of the task performance video to a second video frame of the task performance video along the perpendicular direction, designating the object as an object of interest, and storing mask segmentation data associated with the mask of the object of interest as part of the labeled object data set.

Embodiments of the innovation relate to a segmentation masking apparatus, comprising a controller having a memory and a processor. The controller is configured to receive a task performance video, the task performance video showing of objects within an object stream; play the task performance video in reverse; for each video frame of the task performance video, apply a mask to images of the objects within the object stream; identify an object entering a first video frame of the task performance video along a direction perpendicular to a direction of the object stream; in response to detecting motion of the identified object from the first video frame of the task performance video to a second video frame of the task performance video along the perpendicular direction, designate the object as an object of interest; and store mask segmentation data associated with the mask of the object of interest as part of the labeled object data set.

Embodiments of the innovation relate to an object sorting system, comprising a segmentation masking apparatus and a sorting apparatus disposed in electrical communication with the segmentation masking apparatus. The segmentation masking apparatus comprises a controller having a memory and a processor, the controller of the segmentation masking apparatus configured to: receive a task performance video, the task performance video showing of objects within an object stream; play the task performance video in reverse, for each video frame of the task performance video, apply a mask to images of the objects within the object stream, identify an object entering a first video frame of the task performance video along a direction perpendicular to a direction of the object stream, in response to detecting motion of the identified object from the first video frame of the task performance video to a second video frame of the task performance video along the perpendicular direction, designate the object as an object of interest, and store mask segmentation data associated with the mask of the object of interest as part of the labeled object data set. The sorting apparatus comprises a controller having a memory and a processor, the controller of the sorting apparatus configured to receive the object sorting engine from the segmentation masking apparatus and execute the object sorting engine to identify an object of interest present in a real-time object stream.

### BRIEF DESCRIPTION OF THE DRAWINGS

The foregoing and other objects, features and advantages will be apparent from the following description of particular embodiments of the innovation, as illustrated in the accompanying drawings in which like reference characters refer to the same parts throughout the different views. The drawings are not necessarily to scale, emphasis instead being placed upon illustrating the principles of various embodiments of the innovation.

FIG. 1 illustrates a schematic representation of an object sorting system, according to one arrangement.

FIG. 2 is a flowchart of a process performed by a segmentation masking apparatus of the object sorting system of FIG. 1, according to one arrangement.

FIG. 3A is an image of a first frame of an object stream captured by a video recording device, according to one arrangement.

FIG. 3B is an image of a second frame of the object stream of FIG. 3A captured by the video recording device, according to one arrangement.

FIG. 3C is an image of a third frame of the object stream of FIG. 3A captured by the video recording device, according to one arrangement.

FIG. 3D is an image of a fourth frame of the object stream of FIG. 3A captured by the video recording device, according to one arrangement.

FIG. 4A is a masked image of a fourth frame of the object stream captured by the video recording device, according to one arrangement.

FIG. 4B is an image of the third frame of the object stream of FIG. 4A captured by the video recording device, according to one arrangement.

FIG. 4C is an image of the second frame of the object stream of FIG. 4A captured by the video recording device, according to one arrangement.

FIG. 4D is an image of the first frame of the object stream of FIG. 4A captured by the video recording device, according to one arrangement.

FIG. 5A is a masked image of a first frame of the object stream captured by the video recording device, according to one arrangement.

FIG. 5B is a masked image of a frame, previous to the first frame of FIG. 5A of the object stream captured by the video recording device, according to one arrangement.

FIG. 6 illustrates a schematic representation of a segmentation masking apparatus of the object sorting system of FIG. 1, according to one arrangement.

FIG. 7 illustrates a schematic representation of a segmentation masking apparatus of the object sorting system of FIG. 1, according to one arrangement.

FIG. 8 is a flowchart of a process performed by a segmentation masking apparatus of the object sorting system of FIG. 1, according to one arrangement.

### DETAILED DESCRIPTION

Embodiments of the present innovation relate to a method and apparatus for generating segmentation masks from a task performance video. In one arrangement, a video recording device records a manual object separation process where a human operator make decisions to sort objects from an object stream based on visual information. For example, the operator can be instructed to select and remove particular items or objects (e.g., plastic bottles, aluminum cans, etc.) from an object stream, such as a provided via a conveyor belt. A segmentation masking apparatus can receive the video recording of the manual object separation process, identify the objects picked by the sorting worker. This allows the segmentation masking apparatus to produce pixel-wise masks and labels for the removed objects without requiring additional human supervision and to generate a resulting labeled object data set.

The segmentation masking apparatus can utilize the labeled object data set to train a sorting algorithm to generate a sorting engine. A sorting apparatus can apply real-time video data from an object stream to the training engine to identify objects of interest (e.g., plastic bottles, aluminum cans, etc.). Based on the identification, the sorting apparatus can generate and transmit a signal to one or more robotic devices to remove the identified object from the object stream. The segmentation masking apparatus can also be configured to develop artificial intelligence (AI) algorithms that monitor the process to provide quality control data (e.g., the success of the sorting operation on a conveyor line).

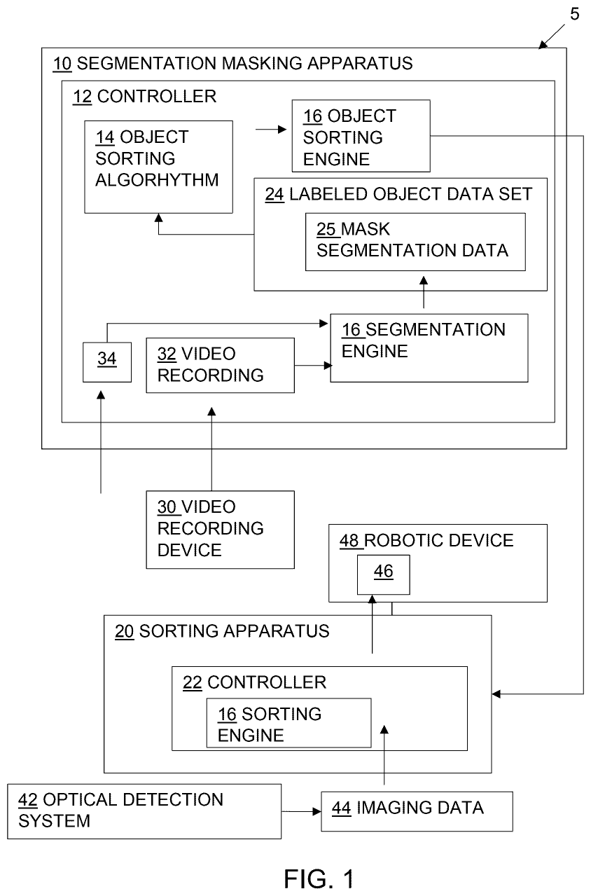

FIG. 1 illustrates an object sorting system 5 having a segmentation masking apparatus 10 disposed in electrical communication with a sorting apparatus 20, according to one embodiment.

The sorting apparatus 20, such as a computerized device, includes a controller 22, such as a processor and memory, that is configured to execute an object sorting engine 16, such as received from the segmentation masking apparatus 10. The sorting apparatus 20 can further include an optical detection system 23, such as one or more camera devices, disposed in electrical communication with the controller 22. During operation, the sorting apparatus 20 can apply real-time video data 42 of an object stream, as received from the optical detection system 42, to the object sorting engine 16. When executing the object sorting engine 16, the sorting apparatus 20 can identify objects of a particular type, such as recyclable materials (e.g., plastic bottles, aluminum cans, etc.) within a real-time object stream.

The segmentation masking apparatus 10, such as a computerized device, includes a controller 12, such as a processor and memory. The controller 12 is configured to generate labeled object data 24 for objects of a particular type, such as recyclable materials (e.g., plastic bottles, aluminum cans, etc.) as found in an object stream, based upon a recorded task performance video 32, such as provided by a video recording device 30. As provided below, the segmentation masking apparatus 10 can be configured to utilize the labeled object data 24 to train an object sorting algorithm 14 and to generate the object sorting engine 16.

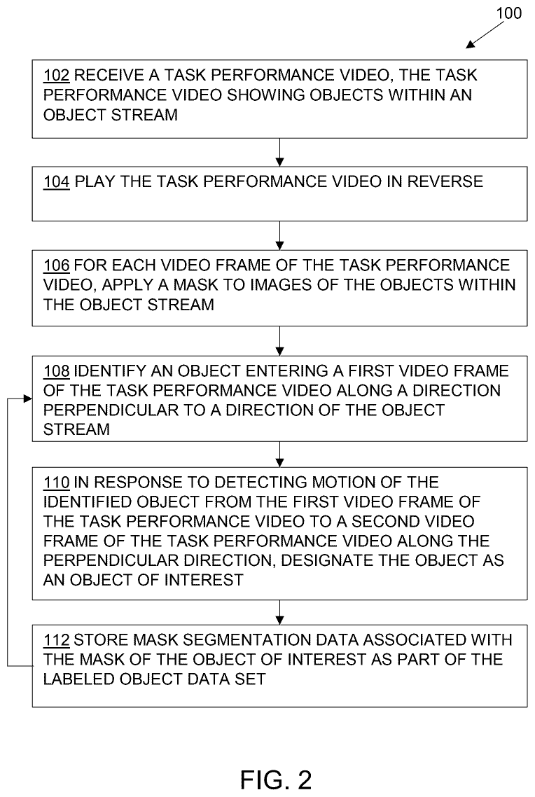

The segmentation masking apparatus 10 can generate the labeled object data 24 in a variety of ways. FIG. 2 is a flowchart 100 of an example process performed by the controller 12 of the segmentation masking apparatus 10 when generating the labeled object data 24, according to one arrangement.

In element 102, the controller 12 receives a task performance video 32, the task performance video 32 showing objects within an object stream 64. The task performance video 32 utilized by the segmentation masking apparatus 10 can be generated in a variety of ways.

In one arrangement, with reference to FIG. 1, a video recording device 30 is configured to record a manual sorting or separation of objects from an object stream 64. As a conveyor 62 moves the objects along direction 50 at a given speed, the video recording device 30 captures frames of the object stream 64 and the removal of the particular type of object from the conveyor at a fixed frame rate. As part of the sorting process, the operator can be tasked with sorting or removing one type of object from the object stream 64. For example, the operator can be tasked with removing particular materials from the stream of recyclable objects carried by the conveyor 62. In another example, the operator can be tasked with removing objects having properties that are not specific to the object's materials, such as all containers (e.g., plastic, aluminum, etc.) originating from a particular manufacturer or source.

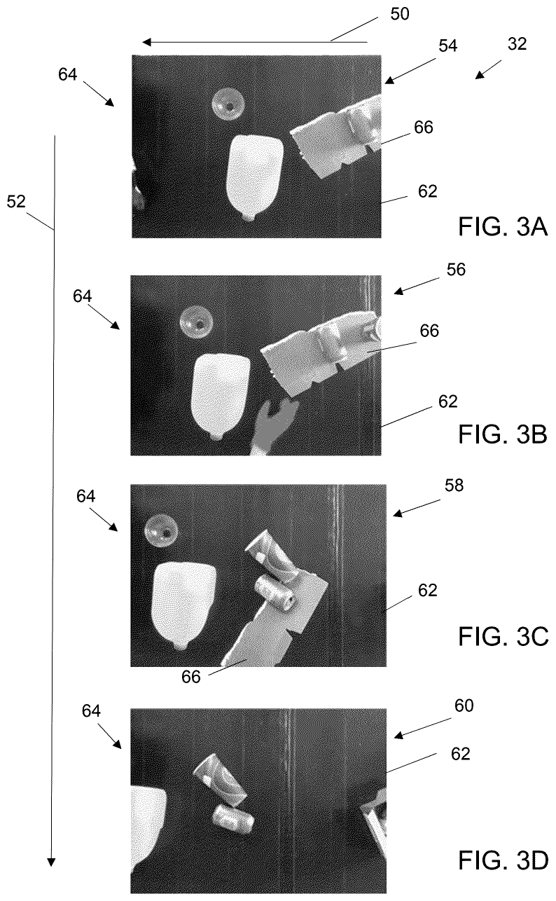

In one arrangement, FIGS. 3A-3D provide a sequence of frames of the task performance video 32 as captured by the video recording device 30 and arranged in a real-time temporal order along direction 52. Temporal order is the arrangement or sequence of events as they happen over time, defining what comes first, next, and last. For example, assume the case where the operator has been tasked with sorting or removing cardboard materials 66 from the object stream 64. FIG. 3A is a first frame 54 showing a conveyor 62 carrying a variety of objects as part of the object stream 64 past an operator workstation along direction 50. As indicated in FIGS. 3B and 3C, the operator identifies (second frame 56) and removes (third frame 58) the cardboard material 66 from the conveyor 62. As shown in FIG. 3D, following removal, the cardboard material 66 is not visible in in the fourth frame 60 of the task performance video 32. The video recording device 30 outputs the resulting task performance video 32 to the segmentation masking apparatus 10 for further processing.

In one arrangement, in addition to receiving the task performance video 32, the segmentation masking apparatus 10 receives an object identifier 34 indicating of the type of object being removed from the object stream 64, termed an object of interest. For example, as provided above, task performance video 32 includes images of the operator sorting or removing cardboard materials 66 from the object stream 64. As such, the object identifier 34 indicates that the objects of interest within the object stream 64 are cardboard materials 66. In one arrangement, the object identifier 34 can provided to the segmentation masking apparatus 10 from video recording device 30 with the task performance video 32.

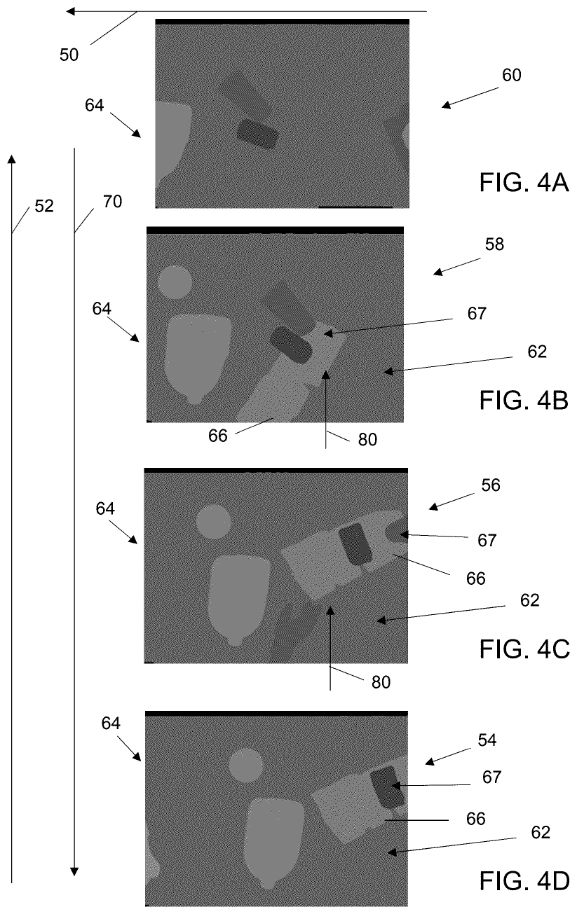

Returning to FIG. 2, in element 104, the controller 12 is configured to play the task performance video 32 in reverse (i.e., from the finish of the video recording backwards to the start of the video recording). For example, as illustrated in FIGS. 4A through 4D, when the controller 12 plays the task performance video 32 backwards, the controller 12 reverses the real-time temporal order (i.e., along direction 52) of the frames in the task performance video 32. As such, the controller 12 is configured to analyze the task performance video 32 in reverse temporal order along direction 70. By reversing the temporal order of the events depicted in the task performance video 32, and starting analysis of the last frame 60 of the task performance video 32, the controller 12 is configured to improve the tracking of objects of interest within the task performance video 32. For example, by playing the task performance video 32 in reverse temporal order along direction 70, a segmentation engine 33 executed by the controller 12 can track the occluding objects 67, such as cans or bottles, on top of the cardboard material 66 since, from the perspective of the segmentation engine 33, the occluding objects 67 appear on the conveyor 37 as part of the background and then a new object, the cardboard material 66, is placed under the occluding objects 67. By contrast, the use of conventional forward temporal propagation struggles with the same sequence. For example, if the task performance video 32 were to be played along direction 52, with reference to frames 54 and 56, a typical segmentation engine would be required to distinguish the occluding objects 67 from the cardboard material 66. In certain cases, rather than identifying the occluding objects 67 as being separate from the cardboard material 66, conventional segmentation engines can merge the masks of the occluding objects 67 and cardboard material 66 into a single mask.

Returning to FIG. 2, in element 106, the controller 12 is configured to, for each video frame 60, 58, 56, 54 of the task performance video 32, apply a mask 72 to images of the objects within the object stream 64. For example, with reference to FIG. 1, the controller 12 is configured to execute a segmentation engine 33 to track and segment objects within the object stream 64 and to identify objects in the object stream 64 by application of various masks 72 (i.e., the differently-shaded objects in frames 60, 58, 56, 54) and to track their flow. In one arrangement, the segmentation engine 33 can be configured to implement a mask consensus algorithm which generates initial object masks on an initial frame 60 and propagates the object masks across subsequent frames 58, 56, 54. Such methods typically use Intersection over Union (IoU) consensus to merge the masks of several adjacent frames together, creating a more robust frame-to-frame segmentation. Further, masking of the objects allows the segmentation masking apparatus 10 to label the objects within the object stream 64 as “out-of-set” or “in-set” since the objects that are removed from the within the object stream 64 are automatically identified via the recording of human actions.

Returning to FIG. 2, in element 108, the controller 12 is configured to identify an object entering a first video frame 58 of the task performance video 32 along a direction approximately perpendicular 80 to a direction of the object stream 50 (e.g., approximately perpendicular to the direction of motion of the conveyor 62). For example, as provided above, because the controller 12 plays the task performance video 32 in reverse temporal order 70, the task performance video 32 appears to show a worker adding objects into the object stream 64 which occurs at a lower or bottom portion of the frames of the task performance video 32. As such, with reference to FIG. 4B, during playback, the controller 12 executing the segmentation engine 33 is configured to identify an object, such as the cardboard material 66, that enters a lower or bottom portion of the initial frame 58 of the task performance video 32, as well as the boundaries of the object.

Returning to FIG. 2, in element 110, the controller 12 is configured to, in response to detecting motion of the identified object from the first video frame 58 of the task performance video 32 to a second video frame 56 of the task performance video 32 along the perpendicular direction 80, designate the object as an object of interest.

In one arrangement, when executing the segmentation engine 33, the controller 12 is configured to review adjacent frames 58, 56 of the task performance video 32 to detect if the movement of an object is a result of human intervention. As provided above, when an object, such as the cardboard material 66, enters a lower or bottom portion of the initial frame 60 of the task performance video 32, such entry is indicative of a worker adding the object into the object stream 64. As such, by identifying motion of the object along the perpendicular direction 80 from the bottom of frames 56 and 58, the controller 12 can designate the object as an object of interest, in this case a cardboard material 66.

Further, with the identification of the object as an object of interest, when executing the segmentation engine 33, the controller 12 can review the masks of the cardboard material 66 across two or more frames, adjust for motion of the conveyor 62 along direction 50, and overlay the masks on top of each other. Depending on the amount of overlap, the controller 12 can determine if a mask represents the same object in multiple frames.

Returning to FIG. 2, in element 112, the controller 12 is configured to store mask segmentation data 25 associated with the mask of the object of interest as part of the labeled object data set 24. In one arrangement, in response to identifying an object in the object stream 64 as being an object of interest, in this case carboard material 66, the controller 12 can collect a variety of types of information as mask segmentation data 25. For example, the controller 12 can include a frame image of the frame 58 of the task performance video 32 as shown in FIG. 3C, a mask image of the identified objects within the object stream 64 within the frame 58 of the task performance video 32 as shown in FIG. 4B, pixel data associated with the mask of the object of interest, such as a list of the specific pixels of the mask of the object, and the object identifier 34 associated with the task performance video 32 where the object identifier 34 identifies the object of interest removed from the object stream 64.

In one arrangement, the segmentation masking apparatus 10 is configured to repeat the process identified in elements 108, 110, and 112 illustrated in FIG. 2 for the duration of the task performance video 32 to generate additional mask segmentation data 25 for the labeled object data set 24. In order to identify the end of a particular object removal sequence, such as illustrated in FIGS. 4A-4D, and the start of new object removal sequence, the controller 12 executing the segmentation engine 33 can be configured to identify removal of the object of interest from the object stream 64 of the task performance video 32.

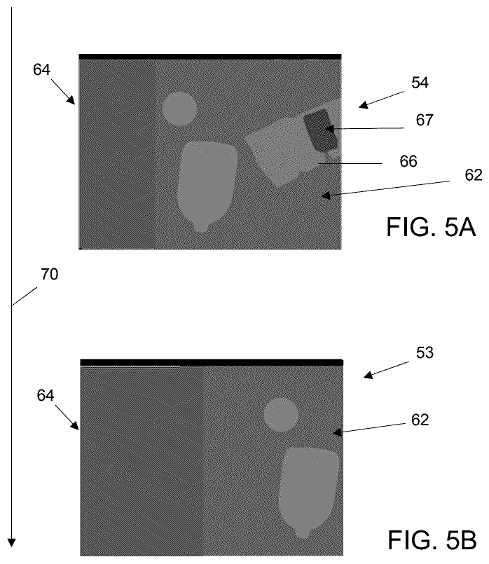

For example, with reference to FIGS. 5A and 5B, the controller 12 is configured to identify motion of the object of interest from the second video frame to a position outside of a subsequent video frame. As indicated, as the controller 12 plays the task performance video 32 in in reverse temporal order along direction 70, the controller 12 is configured to track movement of the mask of the object of interest until it moves out of frame of the task performance video 32, as indicated in frame 53.

Next, based on identification of the object of interest at a position outside of the subsequent video frame 52, the controller 12 can identify the removal of the object of interest from the object stream 64 of the task performance video 32. For example, the controller 12 can mark the object of interest, in this case the carboard material 66, as removed once out of frame 52. With such marking, when a new object enters into a subsequent frame of the task performance video 32, the controller 12 can identify that subsequent frame as a first frame of a new object removal sequence and can execute elements 108, 110, and 112 in FIG. 2.

Accordingly, the segmentation masking apparatus 10 is configured to generate a labeled object data set 24 used to train a sorting algorithm 14. Such generation works at a speed approaching 1,000 times the speed of humans manually annotating images and effectively produces tens of thousands of dollars of labeling an hour.

Returning to FIG. 1, following completion of the analysis of the task performance video 32 and the generation of the labeled object data set 24, the controller 12 of the segmentation masking apparatus 10 can apply the labeled object data set 24 to the object sorting algorithm 14 to train the object sorting algorithm 14 and to generate an object sorting engine 16. For example, the controller 12 is configured to utilize machine learning techniques to teaching the object sorting algorithm 14 to recognize patterns and to make predictions regarding objects of interest. Following generation of the object sorting engine 16, the controller 12 is configured to provide the object sorting engine 16 to the sorting apparatus 20.

The sorting apparatus 20 can execute the object sorting engine 16 to identify objects of interest present in a real-time object stream. For example, the sorting apparatus 20 can be disposed in electrical communication with an optical detection system 42 disposed in proximity to an object stream. As the sorting apparatus 20 receives real-time imaging data 44 of the object stream from the optical detection system 42, the sorting apparatus 20 is configured to apply the imaging data 44 to the object sorting engine 16 to identify objects of a particular type (e.g., plastic bottles, aluminum soda cans, etc.) to be removed from the object stream. Based on the identification, the sorting apparatus 20 is configured to provide a control signal 46 to one or more robotic devices 48, such as robotic arms, which causes the robotic device 48 to remove the identified object from the object stream. As such, the sorting apparatus 20 is configured to distinguish visual identifiers associated with objects and to sort the objects, based on the visual identifiers, without human intervention.

As provided above, the segmentation masking apparatus 10 leverages the inherent temporal asymmetry present during object sorting (i.e., the human sorters only ever remove objects from the object stream 64 and never add more) to visually identify the objects. This allows the segmentation masking apparatus 10 to produce pixel-wise masks and labels for the removed objects without requiring additional human supervision and to generate a resulting labeled object data set. Further, because the segmentation masking apparatus 10 plays the task performance video 32 in reverse, the segmentation engine 33 can more accurately distinguish a removed object (i.e., an object of interest) from other objects present in an object stream 64, thereby increasing the accuracy of the mask segmentation data 25 present within the labeled object data set 24 and the accuracy of the resulting object sorting engine 16. Accordingly, the use of the segmentation masking apparatus 10 improves the operation of the sorting apparatus 20 by allowing the sorting apparatus 20 to more accurately detect and sort objects of interest within a real-time object stream.

As indicated above, the controller 12 executes the segmentation engine 33 to generate masks on the objects of an object stream 64 and to track how the masks associated with the objects move. To help ensure the accuracy of such tracking, when executing the segmentation engine 33, the controller 12 is configured to take several frames of the task performance video 32, such as frames 58, 56, and 54 from FIGS. 4B, 4C, and 4D, respectively, adjust for motion of the fames 58, 56, and 54 along direction 50, and overlay the masks on top of each other, such as the masks for the cardboard material 66 (i.e., the object of interest). Based upon a merger of the overlaid masks, the controller 12 can come to a consensus as to what the segmentation (i.e., the pixel-level isolation of objects within the object stream 64 from the background (e.g., conveyor 62) in the video frame.

However, in cases where the controller 12 tracks object properties (e.g., area, centroids, etc. of masks) in uncertain conditions, such as objects in a recycling stream that can have unclear borders, the segmentation engine 33 may not generate consistent masks. For example, with reference to FIG. 4B, the controller 12 tracks the mask of a piece of cardboard material 66 in the object stream 64 with objects 67 on top of it. During execution of the segmentation engine 33, the controller 12 can flip-flop between identifying the objects 67 on top of the cardboard material 66 as being separate from the cardboard material 66, as shown and being part of the cardboard material 66.

In one arrangement, to maintain consistency between frames when merging overlaid masks and to detect and correct incorrect optical flow tracking, the controller 12 is configured to apply Kalman filtering to the masks generated over a series of frames. Kalman filtering is a standard method used to update object properties when the accuracy of incoming data is unknown. By utilizing Kalman filtering, the controller 12 can estimate the uncertainty of a merged mask's properties; that is, the more uncertain a value is, the less confidence the Kalman filter has in the accuracy of an incoming measurement.

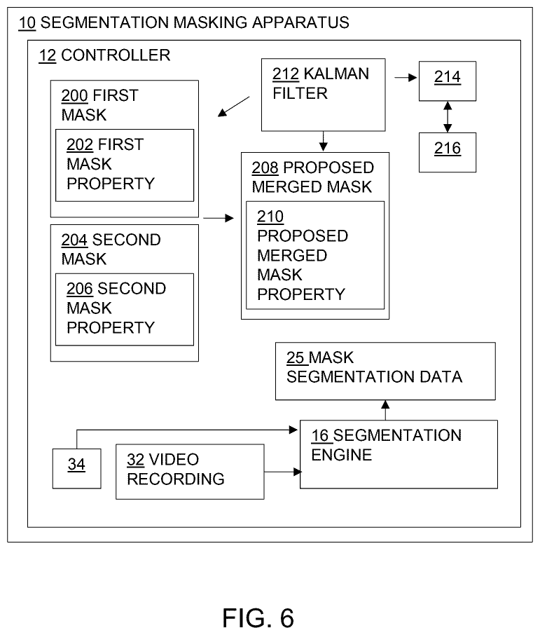

For example, with reference to FIG. 6, during operation the controller 12 is configured to receive a first mask 200 of images of the objects within the object stream for a first video frame of the task performance video 32, the first mask having a first mask property 202. The controller 12 is further configured to receive a second mask 204 of images of the objects within the object stream for a second video frame of the task performance video 32, the second mask 204 having a second mask property 206. In one arrangement, the first and second mask properties 202, 206 relate to the area or the number of pixels associated with each mask. The controller 12 generates a proposed merged mask 208 of the first mask 200 and the second mask 204, the proposed merged mask 208 having a merge mask property 210. In one arrangement, the merge mask property relates to the area or the number of pixels associated with the proposed merged mask 208.

Following generation of the proposed merge mask, the controller 12 is configured to apply a Kalman filter 212 to the first mask 200 and to the proposed merged mask 208. For example, with such application the Kalman filter 212 compares the expected value of the first mask property 202 to the merge mask property 210 of the proposed merged mask 208 and applies a merger expectation threshold 214 to the result 216 of the comparison. For example, assume the first mask property 202 of the first mask 200 indicates the first mask 200 has a mask area of 130 pixels. Further assume the merged mask property 210 of the merged mask 208 indicates the merged mask 208 has a mask area of 150 pixels. When performing the comparison to the Kalman filter 212 takes the difference in the mask areas, 20 pixels, and compares the result 216 to merger expectation threshold 214. Based upon the comparison, the Kalman filter 212 identifies the level of uncertainty or unexpectedness the result 216 of 20 pixels is. For example, if the Kalman filter 212 detects the comparison result 216 as being below the threshold 214, the Kalman filter 212 identifies the proposed merged mask 208 as being certain or expected and allows the merger of the first and second masks 202, 204. By contrast, if the Kalman filter 212 detects the comparison result 216 as meeting or exceeding the threshold 214, the Kalman filter 212 identifies the proposed merged mask 208 as being uncertain or unexpected and deletes does not allows the merger of the first and second masks 202, 204. As such, the controller 12 can delete the second mask 204.

With such a configuration, the controller 12 uses a Kalman filter 212 to detect and correct incorrect optical flow tracking. As such, the Kalman filter 212 check each proposed merge action to see how the merger affects the resulting proposed mask's uncertainty. Accordingly, use of the Kalman filter 212 can provides fewer mask mismatches during merger, thereby generating a more accurate labeled object data set 24 which has an output that is more similar to what a human would annotate.

In one arrangement, to delay the decision-making process used in the application of the Kalman filter 212 but maintain consistency between frames when merging overlaid masks and to detect and correct incorrect optical flow tracking, the controller 12 is configured to apply multi-hypothesis testing to the masks generated over a series of frames.

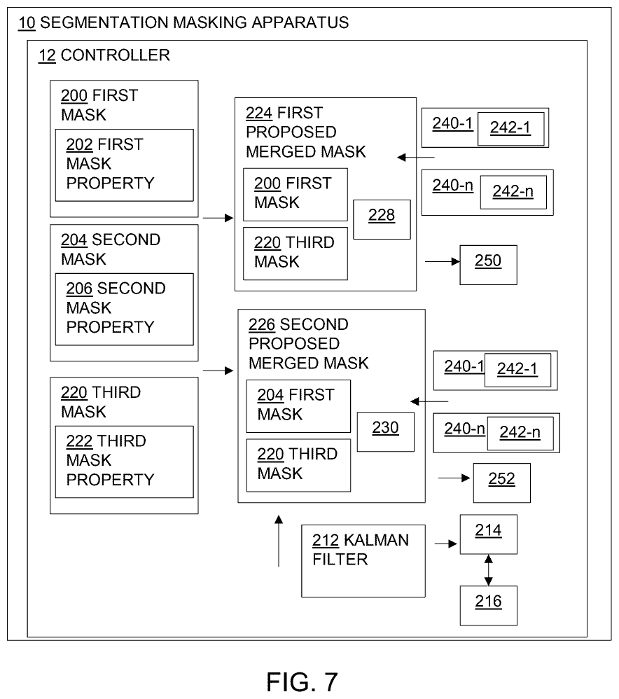

For example, with reference to FIG. 7, during operation the controller 12 is configured to receive a first mask 200 of images of the objects within the object stream for a first video frame of the task performance video 32, the first mask having a first mask property 202. The controller 12 is further configured to receive a second mask 204 of images of the objects within the object stream for a second video frame of the task performance video 32, the second mask 204 having a second mask property 206. The controller 12 is further configured to receive a third mask 220 of images of the objects within the object stream for a third video frame of the task performance video 32, the third mask 220 having a third mask property 222. In one arrangement, the first, second, and third mask properties 202, 206, 222 relate to the area or the number of pixels associated with each mask.

Next, the controller 12 is configured to generate a first proposed merged mask 224 of the first mask 202 and the third mask 220 where the first proposed merged mask 224 has a first merge mask property 228. Additionally, the controller 12 is configured to generate a second proposed merged mask 226 of the second mask 206 and the third mask 220 where the second proposed merged mask has a second merge mask property 230. The controller 12 can then merge new, or subsequent, frames 240-1 through 240-n having subsequent mask properties 242-1 through 242-n with each of the first proposed merged mask 224 to generate a first proposed merged mask sequence 250 and the second proposed merged mask 226 to generate a second proposed merged mask sequence 252.

Following generation of the proposed merge mask, the controller 12 is configured to apply a Kalman filter 212 to the first proposed merged mask sequence 250 and to the second proposed merged mask sequence 252 to compare a value of the first merge mask property 228 to a value of the second merge mask property 230 to generate a comparison result 216. Based upon the comparison, the Kalman filter 212 identifies the level of uncertainty or unexpectedness of the result 216.

As provided above, the segmentation masking apparatus 10 is configured to generate labeled object data 24 for objects of a particular type, such as recyclable materials (e.g., plastic bottles, aluminum cans, etc.) as found in an object stream, based upon a recorded task performance video 32, such as provided by a video recording device 30. In one arrangement, the segmentation masking apparatus 10 can be configured to utilize the labeled object data 24 to perform a throughput analysis on the object stream 64 to provide an operator with an estimate of the composition of an object stream 64.

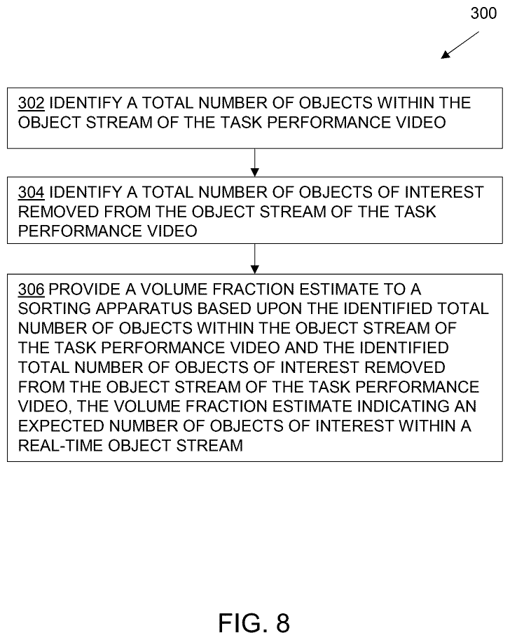

For example, with reference to the flowchart 300 of FIG. 8, in element 302, the controller 12 of the segmentation masking apparatus 10 is configured to identify a total number of objects within the object stream 64 of the task performance video 32. For example, the controller 12 can count the total number of masked objects within the object stream 64, as provided during the entirety of the task performance video 32.

In element 304, the controller 12 of the segmentation masking apparatus 10 is configured to identify a total number of objects of interest removed from the object stream 64 of the task performance video 32. For example, in the present example, the controller 12 can count the total number of cardboard material elements 66 removed from the object stream 64, as provided during the entirety of the task performance video 32.

In element 306, the controller 12 of the segmentation masking apparatus 10 is configured to provide a volume fraction estimate to a sorting apparatus 20 based upon the identified total number of objects within the object stream 64 of the task performance video 32 and the identified total number of objects of interest removed from the object stream 64 of the task performance video 32, the volume fraction estimate indicating an expected number of objects of interest within a real-time object stream. For example, the controller 12 of the segmentation masking apparatus 10 can subtract the number of cardboard material elements 66 removed from the object stream 64 from the total number of objects counted within the object stream 64 to generate the volume fraction estimate. The volume fraction estimate allows the sorting device 20 to better understand of the makeup of the real-time object stream it processes.

While various embodiments of the innovation have been particularly shown and described, it will be understood by those skilled in the art that various changes in form and details may be made therein without departing from the spirit and scope of the innovation as defined by the appended claims.

What is claimed is:

1. In a segmentation masking apparatus, a method for generating a labeled object data set, comprising:
receiving a task performance video, the task performance video showing of objects within an object stream;
playing the task performance video in reverse;
for each video frame of the task performance video, applying a mask to images of the objects within the object stream;
identifying an object entering a first video frame of the task performance video along a direction perpendicular to a direction of the object stream;
in response to detecting motion of the identified object from the first video frame of the task performance video to a second video frame of the task performance video along the perpendicular direction, designating the object as an object of interest; and
storing mask segmentation data associated with the mask of the object of interest as part of the labeled object data set.

2. The method of claim 1, further comprising
identifying motion of the object of interest from the second video frame to a position outside of a subsequent video frame; and
based on identification of the object of interest to the position outside of the subsequent video frame, identifying removal of the object of interest from the object stream of the task performance video.

3. The method of claim 1, further comprising:
identifying a total number of objects within the object stream of the task performance video;
identifying a total number of objects of interest removed from the object stream of the task performance video; and
providing a volume fraction estimate to a sorting apparatus based upon the identified total number of objects within the object stream of the task performance video and the identified total number of objects of interest removed from the object stream of the task performance video, the volume fraction estimate indicating an expected number of objects of interest within a real-time object stream.

4. The method of claim 1, comprising:
receiving a first mask of images of the objects within the object stream for a first video frame of the task performance video, the first mask having a first mask property;
receiving a second mask of images of the objects within the object stream for a second video frame of the task performance video, the second mask having a second mask property;
generating a proposed merged mask of the first mask and the second mask, the proposed merged mask having a merge mask property;
applying a Kalman filter to the first mask and to the proposed merges mask to compare an expected value of the first mask property to the merge mask property of the proposed merged mask to generate a comparison result;
applying a merger expectation threshold to the comparison result;
if the comparison result falls below the merger expectation threshold, allowing merger of the first mask and the second mask; and
if the comparison result meets the merger expectation threshold, disallowing merger of the first mask and the second mask.

5. The method of claim 1, comprising:
receiving a first mask of images of the objects within the object stream for a first video frame of the task performance video, the first mask having a first mask property;
receiving a second mask of images of the objects within the object stream for a second video frame of the task performance video, the second mask having a second mask property;
receiving a third mask of images of the objects within the object stream for a third video frame of the task performance video, the third mask having a third mask property generating a first proposed merged mask of the first mask and the third mask, the first proposed merged mask having a first merge mask property;
generating a second proposed merged mask of the second mask and the third mask, the second proposed merged mask having a second merge mask property;
merging each subsequently received mask of images of the objects within the object stream for subsequent video frames of the task performance video with the first proposed merged mask to generate a first proposed merged mask sequence and with the second proposed merged mask to generate a second proposed merged mask sequence, each of the subsequent masks having a subsequent mask property;
applying a Kalman filter to the first proposed merged mask sequence and to the second proposed merged mask sequence to compare a value of the first merge mask property to a value of the second merge mask property to generate a comparison result;
applying a merger expectation threshold to the comparison result;
if the comparison result falls below the merger expectation threshold, allowing merger of the first mask and the second mask; and
if the comparison result meets the merger expectation threshold, disallowing merger of the first mask and the second mask.

6. The method of claim 1, wherein storing mask segmentation data associated with the object of interest as part of a labeled object data set comprises storing, as part of the labeled object data set, at least one of a frame image of the frame of the task performance video, a mask image of the identified objects within the object stream within the frame of the task performance video, pixel data associated with the mask of the object of interest, and the object identifier associated with the task performance video, the object identifier identifying the object of interest removed from the object stream.

7. The method of claim 1, further comprising:
training an object sorting algorithm with the labeled object data set to generate an object sorting engine; and
providing the object sorting engine to a sorting apparatus, the sorting apparatus configured to execute the object sorting engine to identify the object of interest present in a real-time object stream.

8. A segmentation masking apparatus, comprising a controller having a memory and a processor, the controller configured to:
receive a task performance video, the task performance video showing of objects within an object stream;
play the task performance video in reverse;
for each video frame of the task performance video, apply a mask to images of the objects within the object stream;
identify an object entering a first video frame of the task performance video along a direction perpendicular to a direction of the object stream;
in response to detecting motion of the identified object from the first video frame of the task performance video to a second video frame of the task performance video along the perpendicular direction, designate the object as an object of interest; and
store mask segmentation data associated with the mask of the object of interest as part of the labeled object data set.

9. The segmentation masking apparatus of claim 8, wherein the controller is configured to:
identify motion of the object of interest from the second video frame to a position outside of a subsequent video frame; and
based on identification of the object of interest to the position outside of the subsequent video frame, identify removal of the object of interest from the object stream of the task performance video.

10. The segmentation masking apparatus of claim 8, wherein the controller is further configured to:
identify a total number of objects within the object stream of the task performance video;
identify a total number of objects of interest removed from the object stream of the task performance video; and
provide a volume fraction estimate to a sorting apparatus based upon the identified total number of objects within the object stream of the task performance video and the identified total number of objects of interest removed from the object stream of the task performance video, the volume fraction estimate indicating an expected number of objects of interest within a real-time object stream.

11. The segmentation masking apparatus of claim 8, wherein the controller is configured to:
receive a first mask of images of the objects within the object stream for a first video frame of the task performance video, the first mask having a first mask property;
receive a second mask of images of the objects within the object stream for a second video frame of the task performance video, the second mask having a second mask property;
generate a proposed merged mask of the first mask and the second mask, the proposed merged mask having a merge mask property;
apply a Kalman filter to the first mask and to the proposed merges mask to compare an expected value of the first mask property to the merge mask property of the proposed merged mask to generate a comparison result;
apply a merger expectation threshold to the comparison result;
if the comparison result falls below the merger expectation threshold, allow merger of the first mask and the second mask; and
if the comparison result meets the merger expectation threshold, disallow merger of the first mask and the second mask.

12. The segmentation masking apparatus of claim 8, wherein the controller is further configured to:
receive a first mask of images of the objects within the object stream for a first video frame of the task performance video, the first mask having a first mask property;
receive a second mask of images of the objects within the object stream for a second video frame of the task performance video, the second mask having a second mask property;
receive a third mask of images of the objects within the object stream for a third video frame of the task performance video, the third mask having a third mask property generate a first proposed merged mask of the first mask and the third mask, the first proposed merged mask having a first merge mask property;
generate a second proposed merged mask of the second mask and the third mask, the second proposed merged mask having a second merge mask property;
merge each subsequently received mask of images of the objects within the object stream for subsequent video frames of the task performance video with the first proposed merged mask to generate a first proposed merged mask sequence and with the second proposed merged mask to generate a second proposed merged mask sequence, each of the subsequent masks having a subsequent mask property;
apply a Kalman filter to the first proposed merged mask sequence and to the second proposed merged mask sequence to compare a value of the first merge mask property to a value of the second merge mask property to generate a comparison result;
apply a merger expectation threshold to the comparison result;
if the comparison result falls below the merger expectation threshold, allow merger of the first mask and the second mask; and
if the comparison result meets the merger expectation threshold, disallow merger of the first mask and the second mask.

13. The segmentation masking apparatus of claim 8, wherein when storing mask segmentation data associated with the object of interest as part of a labeled object data set, the controller is configured to store, as part of the labeled object data set, at least one of a frame image of the frame of the task performance video, a mask image of the identified objects within the object stream within the frame of the task performance video, pixel data associated with the mask of the object of interest, and the object identifier associated with the task performance video, the object identifier identifying the object of interest removed from the object stream.

14. The segmentation masking apparatus of claim 8, wherein the controller is further configured to:
train an object sorting algorithm with the labeled object data set to generate an object sorting engine; and
provide the object sorting engine to a sorting apparatus, the sorting apparatus configured to execute the object sorting engine to identify the object of interest present in a real-time object stream.

15. An object sorting system, comprising:
a segmentation masking apparatus comprising a controller having a memory and a processor, the controller of the segmentation masking apparatus configured to:
receive a task performance video, the task performance video showing of objects within an object stream;
play the task performance video in reverse,
for each video frame of the task performance video, apply a mask to images of the objects within the object stream,
identify an object entering a first video frame of the task performance video along a direction perpendicular to a direction of the object stream,
in response to detecting motion of the identified object from the first video frame of the task performance video to a second video frame of the task performance video along the perpendicular direction, designate the object as an object of interest, and
store mask segmentation data associated with the mask of the object of interest as part of the labeled object data set, and
a sorting apparatus disposed in electrical communication with the segmentation masking apparatus, the sorting apparatus comprising a controller having a memory and a processor, the controller of the sorting apparatus configured to:
receive the object sorting engine from the segmentation masking apparatus; and
execute the object sorting engine to identify an object of interest present in a real-time object stream.

16. The object sorting system of claim 15, wherein the controller of the segmentation masking apparatus is configured to:
identify motion of the object of interest from the second video frame to a position outside of a subsequent video frame; and
based on identification of the object of interest to the position outside of the subsequent video frame, identify removal of the object of interest from the object stream of the task performance video.

17. The object sorting system of claim 15, wherein the controller of the segmentation masking apparatus is configured to:
identify a total number of objects within the object stream of the task performance video;
identify a total number of objects of interest removed from the object stream of the task performance video; and
provide a volume fraction estimate to a sorting apparatus based upon the identified total number of objects within the object stream of the task performance video and the identified total number of objects of interest removed from the object stream of the task performance video, the volume fraction estimate indicating an expected number of objects of interest within a real-time object stream.

18. The object sorting system of claim 15, wherein:
when applying the mask to the object of interest within the subsequent video frame of the task performance video, the controller of the segmentation masking apparatus is configured to:
detect a change in a mask property of the mask of the object of interest from the video frame of the task performance video to the mask property of the mask of object of interest in the subsequent video frame of the task performance video, and
in response to detecting the change in the mask property, apply a Kalman filter to the mask of the object of interest from the video frame of the task performance video and to the mask of object of interest in the subsequent video frame of the task performance video to identify an accuracy of the detected change in the mask property; and
when storing mask segmentation data associated with the mask of the object of interest within the subsequent video frame of the task performance video as part of the labeled object data set, the controller of the segmentation masking apparatus is configured to:
store mask segmentation data associated with the mask of the object of interest within the subsequent video frame of the task performance video as part of the labeled object data set when the accuracy of the detected change in the mask property falls below a detection threshold.

19. The object sorting system of claim 15, wherein the controller of the segmentation masking apparatus is further configured to
receive a first mask of images of the objects within the object stream for a first video frame of the task performance video, the first mask having a first mask property;
receive a second mask of images of the objects within the object stream for a second video frame of the task performance video, the second mask having a second mask property;
receive a third mask of images of the objects within the object stream for a third video frame of the task performance video, the third mask having a third mask property
generate a first proposed merged mask of the first mask and the third mask, the first proposed merged mask having a first merge mask property;
generate a second proposed merged mask of the second mask and the third mask, the second proposed merged mask having a second merge mask property;
merge each subsequently received mask of images of the objects within the object stream for subsequent video frames of the task performance video with the first proposed merged mask to generate a first proposed merged mask sequence and with the second proposed merged mask to generate a second proposed merged mask sequence, each of the subsequent masks having a subsequent mask property;
apply a Kalman filter to the first proposed merged mask sequence and to the second proposed merged mask sequence to compare a value of the first merge mask property to a value of the second merge mask property to generate a comparison result;
apply a merger expectation threshold to the comparison result;
if the comparison result falls below the merger expectation threshold, allow merger of the first mask and the second mask; and
if the comparison result meets the merger expectation threshold, disallow merger of the first mask and the second mask.

20. The object sorting system of claim 15, wherein when storing mask segmentation data associated with the object of interest as part of a labeled object data set, the controller of the segmentation masking apparatus is configured to store, as part of the labeled object data set, at least one of a frame image of the frame of the task performance video, a mask image of the identified objects within the object stream within the frame of the task performance video, pixel data associated with the mask of the object of interest, and the object identifier associated with the task performance video, the object identifier identifying the object of interest removed from the object stream.

21. The object sorting system of claim 15, wherein the controller of the segmentation masking apparatus is configured to:
train an object sorting algorithm with the labeled object data set to generate an object sorting engine; and
provide the object sorting engine to a sorting apparatus, the sorting apparatus configured to execute the object sorting engine to identify the object of interest present in a real-time object stream.
